(19) United States
(12) Patent Application Publication
(10) Pub. No.: US 2006/0095158 A1
(43) Pub. Date: May 4, 2006

(54) Robot control system and robot control method thereof

(75) Inventors: Ju-sang Lee, Gwangju-City (KR); Jang-youn Ko, Gwangju-City (KR); Ki-man Kim, Gwangju-City (KR); Jeong-gon Song, Gwangju-City (KR); Kwang-soo Lim, Seoul (KR); Sam-jong Jeung, Gwangju-City (KR)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Samsung Gwangju Electronics Co., Ltd

(21) Appl. No.: 11/133,001

(22) Filed: May 19, 2005

(30) Foreign Application Priority Data
Oct. 29, 2004 (KR) 2004-87094

(51) Int. Cl. G06F 19/00

(52) U.S. Cl. 700/245; 318/568.12

(57) ABSTRACT

A robot control system and a robot control method provide improved user convenience in operating the system. The robot control system includes a wireless IP sharing device, connected with the Internet, for transmitting and receiving an image signal and/or a control signal, a robot running by itself in accordance with a command received through the wireless IP sharing device, and performing a designated job, the robot being installed with a wireless communication module, a portable wireless terminal having a motion sensor, for wirelessly transmitting an operation command to the wireless communication module, or receiving image signal and/or control signal, and a robot server, connected with the Internet, for outputting a control screen of the robot, and the image signal and/or the control signal which is received from the robot, to the portable wireless terminal. The robot is controlled by use of the motion sensor installed at the portable wireless terminal.

### CROSS-REFERENCE TO RELATED APPLICATIONS

This application claims the benefit of Korean Patent Application No. 2004-87094 filed Oct. 29, 2004, in the Korean Intellectual Property Office, the disclosure of which is incorporated herein by reference.

### BACKGROUND OF THE INVENTION

1. Field of the Invention

The present invention relates to a robot control method. More particularly, the present invention relates to a robot control system and a robot control method that enables a user to conveniently control a service robot such as a cleaning robot and an entertainment robot.

2. Description of the Related Art

Service robots are widely used for many purposes such as park cleaning, home cleaning, errands, entertainment and security. Such service robots are usually controlled by remote control using a plurality of buttons on a personal computer. However, because a control signal is transmitted through a modem, the PC-based controlling requires complicated control structure and accompanies with deteriorated mobility.

Meanwhile, JP2002-354139 disclosed a control system using a mobile phone in an effort to solve the above-mentioned problems. According to JP2002-354139, a user calls with his mobile phone to a mobile phone mounted on the cleaner robot, selects places for cleaning operation using buttons on his mobile phone, and transmits cleaning commands. However, because the mobile phones are usually compact-sized and have a minimum number of buttons, it is somewhat difficult to design operation functions variously, and accordingly, operability deteriorates.

Korean Patent No. 0441087 disclosed a cleaning system that is equipped with a cleaner robot control device attachable to a surface such as a refrigerator door. This system, however, requires the control device to attach to an electronic appliance that is communicable with the external communication network, and therefore, has degraded portability. Besides, it is difficult to control the cleaner robot from outside.

### SUMMARY OF THE INVENTION

The present invention has been developed in order to solve the above drawbacks and other problems associated with the conventional arrangement. An aspect of the present invention is to provide a robot control system and a robot control method thereof, which is capable of controlling a service robot from almost anywhere and with convenience.

It is another aspect of the present invention to provide a robot control system and a robot control method thereof, which provides the user with improved operability.

The above aspects and/or other features of the present invention can substantially be provided by providing a robot control system, which includes a wireless IP sharing device, connected with the Internet, for transmitting and receiving an image signal and/or a control signal, a robot running by itself in accordance with a command received through the wireless IP sharing device, and performing a designated job, the robot being installed with a wireless communication module, a portable wireless terminal having a motion sensor, for wirelessly transmitting an operation command to the wireless communication module, or receiving image signal and/or control signal, and a robot server, connected with the Internet, for outputting a control screen of the robot, and the image signal and/or the control signal which is received from the robot, to the portable wireless terminal. The robot may be controlled by use of the motion sensor installed at the portable wireless terminal.

The portable wireless terminal may include a display window for outputting the controls screen, and a button unit, and the motion sensor is installed at a lower side of the portable wireless terminal.

The portable wireless terminal may further include a joystick unit which is selectively connected with a connection socket of the potable wireless terminal, and the robot is controlled by use of the joystick unit. The robot may be a cleaner robot.

According to one aspect of the present invention, a robot control method includes the steps of a) inputting an ID and a password using a portable wireless terminal which is connected with the Internet, b) determining whether the inputted ID and the password are registered in a robot server, c) if the ID and the password are registered in the robot server, connecting to a robot corresponding to the ID, d) outputting a control screen of the robot through a display window of the portable wireless terminal, e) inputting an operation command by use of a motion sensor installed at the portable wireless terminal and the control screen, f) transmitting the operation command inputted through the portable wireless terminal, to the robot via the wireless IP sharing device which is connected with the Internet, and g) outputting the image signal and/or the control signal from the robot through the display window of the portable wireless terminal via the wireless IP sharing device.

The step e) inputs the operation command by moving the main body of the portable wireless terminal and selecting a menu on the control screen.

According to the present invention, a robot at a remote distance can be conveniently controlled by use of mobile phone, which is quite portable, and the Internet. As a result, user convenience increases.

Furthermore, because the control screen can be controlled by moving the main body of the mobile phone, there is no need for the user to input operation command by pressing small buttons on the mobile phone, and as a result, user convenience increases.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating a robot control system according to an embodiment of the present invention;

FIG. 2 is a perspective view of a cleaner robot according to an embodiment of the present invention;

FIG. 3 is a perspective view of the cleaner robot with an upper cover removed to show interior construction thereof;

FIG. 4 is a block diagram of a robot control system according to an embodiment of the present invention;

FIGS. 5 and 6 are perspective views illustrating the structure of a mobile phone as an example of a wireless terminal;

FIG. 7 is a view illustrating the way of operating the mobile phone of FIGS. 5 and 6; and

FIG. 8 is a block diagram illustrating a robot control method according to an embodiment of the present invention.

### DETAILED DESCRIPTION OF THE PREFERRED EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

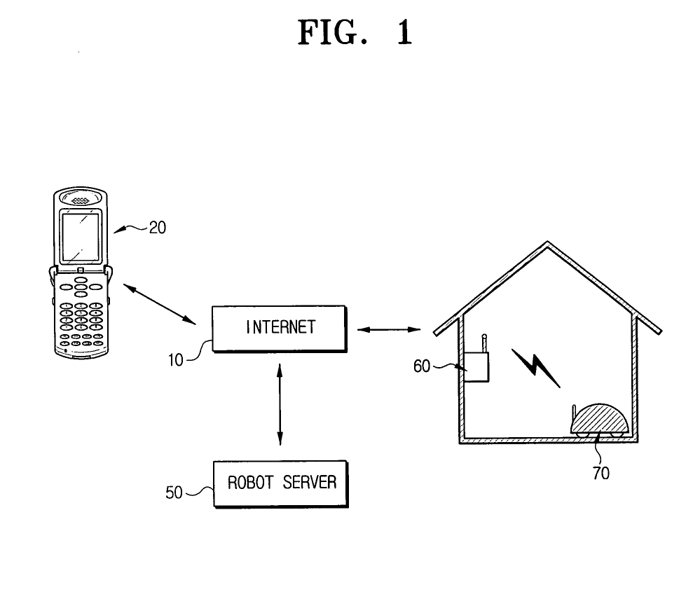

Referring to FIG. 1, a robot control system according to one aspect of the present invention includes a cleaner robot 70, a wireless Internet protocol (IP) sharing device 60, a mobile phone 20 and a robot server 50. In the present embodiment, the cleaner robot 70 may be replaced with a variety of service robots such as, but not limited to, a security robot and an errand robot. The mobile phone 20 may also be replaced with a variety of wireless terminals.

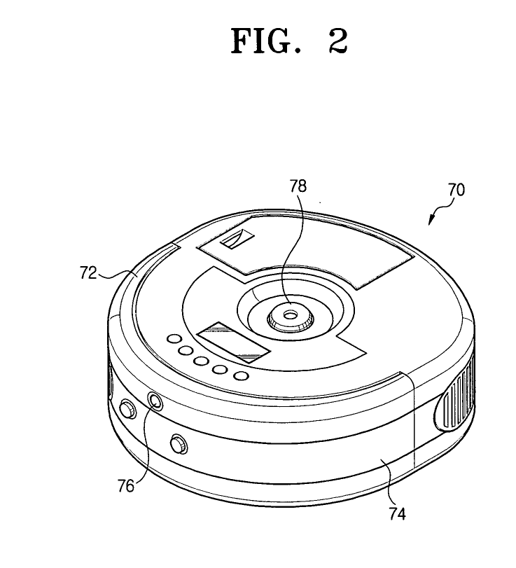

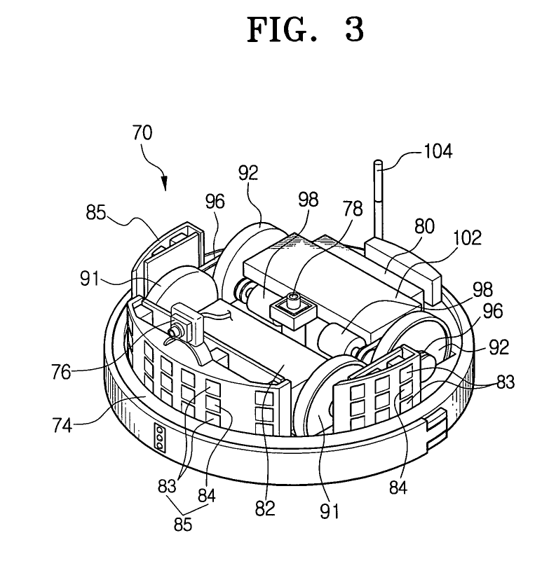

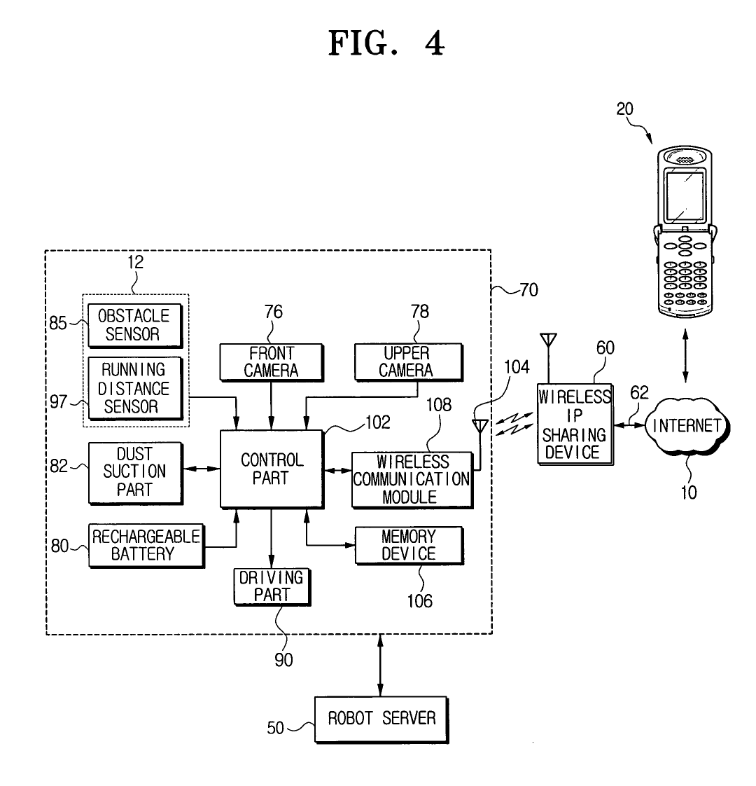

Referring to FIGS. 2 through 4, the cleaner robot 70 includes a main body 74, a sensor part 12, a dust suction part 82, a driving part 90, an upper camera 78, a front camera 76, a control part 102, a memory device 106, a wireless communication module 108 and a rechargeable battery 80.

The sensor part 12 includes an obstacle sensor 85 arranged at predetermined intervals along the surface of the main body 74 to send out a signal and receive reflected signals, and a running distance sensor 97 which measures a running distance of the cleaner robot 70.

The obstacle sensor 85 includes a plurality of infrared light emitting elements 83 for emitting rays of infrared light and a plurality of light receiving elements 84 for receiving reflected beam. The light emitting and receiving elements 83,84 being arranged along the outer circumference of the main body 74 in a substantially vertical pattern. Each light emitting element 83 is paired with the light receiving element 84. The obstacle sensor 85 may alternatively include an ultrasound sensor that emits an ultrasound wave and receives reflected ultrasound wave. The obstacle sensor 85 may also be used to measure the distance from the cleaner robot 70 to obstacle or wall.

The running distance sensor 97 may include a RPM sensor that detects RPM (revolutions per minute) of wheels 91 and 92 of the driving part 90. For example, the RPM sensor may be a rotary encoder which detects the RPM of the motor 98.

The dust suction part 82 is provided on the main body 74 to draw in dust from the opposite surface. The dust suction part 82 may be constructed in a variety of known ways. For example, the dust suction part 82 may include a suction motor (not shown), and a dust chamber (not shown), which collects therein dust that is drawn in by the suction motor via a suction port or the suction pipe.

The driving part 90 includes two front wheels 91 at both front sides, two rear wheels 92 at both rear sides, motors 98 for driving the rear wheels 92, respectively, and a timing belt 96 to transmitting driving force of the rear wheels 92 to the front wheels 91. The driving part 90 rotates the respective motors 98 independently, in a forward or backward direction in accordance with a control signal from the control part 102. The running direction of the cleaner robot 70 can be changed by varying the RPM of the respective motors 98.

The front camera 76 is mounted on the main body 74 to photograph the images in front of the cleaner robot 70 and to send the photographed images to the control part 102.

The upper camera 78 is mounted on the main body 74 of the cleaner robot 70 to photograph images above the cleaner robot 70 and to output the captured images to the control part 102. CCD (charge-coupling device) cameras may be used as the front and upper cameras 74 and 78.

The wireless communication module 108 sends out an image signal with respect to the images captured through the front and the upper cameras 78 and 76, or a control signal for the cleaner robot 70 to the wireless IP sharing device 60, and transmits a signal that is received from the wireless IP sharing device 60 via an antenna 104, to the control part 102. The wireless communication module 108 may be a USB wireless adapter or a PCMCIA (Personal Computer Memory Card International Association) wireless LAN card which can be compatibly used with the wireless IP sharing device 60.

The rechargeable battery 80 is mounted on the main body 74, to supply the power necessary for the operation of the motors 98 or the control part 102 of the cleaner robot 70.

The control part 102 processes the signal received from the mobile phone 20 via the wireless communication module 108, and accordingly controls the respective components. When a key input device (not shown) having a plurality of keys for manipulating functions of the cleaner robot 70 is provided on the main body 74, the control part 102 may process the key signal inputted from the key input device.

In order to use the images photographed through the upper camera 78 as a location indicating mark, the control part 102 extracts location indicating marks from the ceiling of the operation area, and perceives the current position of the cleaner robot 70 based on the extracted location information. The control part 102 then controls the respective parts to perform desired jobs based on the perceived current position. Also according to the received command, the control part 102 converts the images captured through the front camera 76 into image signal and sends the converted image signal to the wireless communication module 108. Accordingly, the image signal is outputted to the mobile phone 20 which is accessed to the robot server 50 via the Internet, and therefore, the location of the cleaner robot 70 can be viewed.

The wireless IP sharing device 60 is connected with the internet line 62, to output the data from the mobile phone to the cleaner robot 70, and receive image signal or control signal of the cleaner robot 70, which is received via the wireless communication module 108 of the cleaner robot 70, and transmit the received signal to the robot server 50 which is also connected via the internet line 62.

The robot server 50 may be hosted by the manufacturer of the cleaner robot 70, and it can be connected with a plurality of cleaner robots 70 via the Internet 10. Each of the cleaner robots 70 stores therein IP addresses, serial numbers, ID's, and passwords of the plurality of other cleaner robots 70. Upon receipt of an ID and password input by the user through the mobile phone 20, the robot server 50 looks up the IP address of the cleaner robot 70 matching with the input ID and password, and therefore, connects to the corresponding cleaner robot 70. The robot server 50 designates unique ID and password for each cleaner robot 70, and allocates the cleaner robot 70 with corresponding IP address and serial number so that an authorized user can access the cleaner robot 70. Therefore, by inputting a given ID and password using the mobile phone 20, the user can access his robot 70. Additionally, a remote control program may be installed so that, with the access of mobile phone 20, a screen for cleaner robot control may be output to the display window 26 (see FIG. 6) of the mobile phone 20.

The mobile phone 20 is connectable to the internet wirelessly, and capable of bilateral communication of signals. The mobile phone 20 includes an input part to input commands, and an output part to output image and control screen.

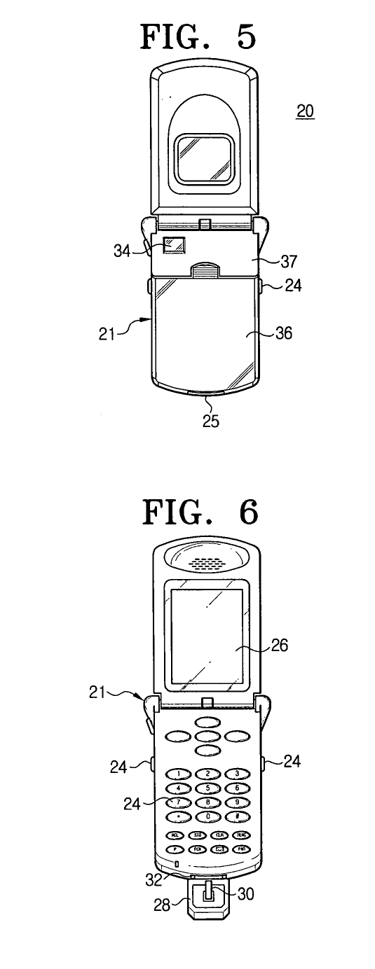

Referring to FIGS. 5 through 7, the input part includes buttons 24 and a motion sensor 34. The motion sensor 34 is formed on the upper part of the battery 36 at the rear side of the mobile phone main body 21. A battery recharger (not shown) may be removably mounted on a side of the mobile phone main body 21, or a socket 25 may be formed on a side of the mobile phone main body 21 to removably receive a joystick unit 28 as shown in FIG. 6. The motion sensor 34 senses motion displacement by use of optical navigation system, and is widely available in the market. The motion sensor 34 captures the images it faces, using lighting system and lenses, and determines direction and distance of movement through the digital signal processing. The input part is constructed such that the determined data are outputted to a controller via the converter.

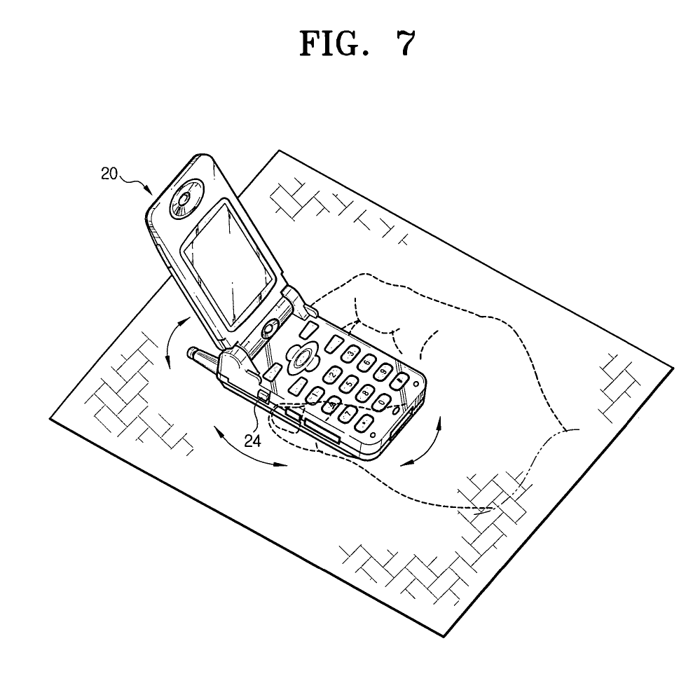

Referring to FIG. 6, the output part includes the display window 26. The present embodiment utilizes the general display window equipped in the mobile phone 20 to obtain unique advantage of the present invention. More specifically, the motion sensor 34 can be provided to a general mobile phone 20 so that user can enjoy more user-friendly environment. The joystick unit 28 may be removably attached to the socket 25 according to the selection by the user. As shown in FIG. 7, the user simply places his mobile phone 20 on a proper surface such as his palm, grabs the mobile phone main body 21, and controls the cleaner robot 70 through the control screen appearing on the display window 26. Alternatively, the user may control the cleaner robot 70 through the control screen appearing on the display window 26 by using the joystick 30 of the joystick unit 28 which is connected with the mobile phone 20 (see FIG. 6).

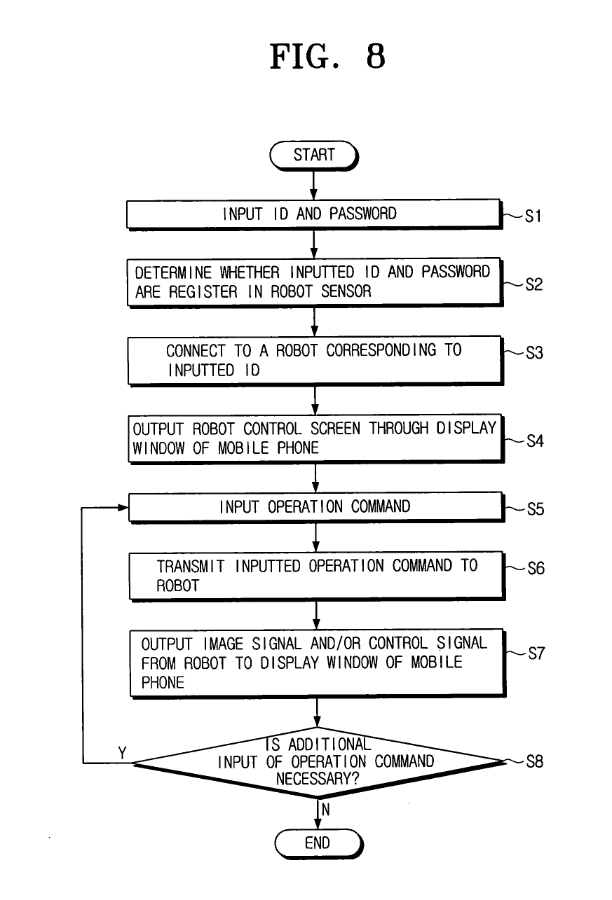

Controlling by the mobile phone 20 connected to the robot server 50 and the cleaner robot 70 will now be described in greater detail below with reference to FIG. 8.

First, the user inputs ID and password by using the buttons 24 on the mobile phone 20 to connect to the server 50 (step S1).

The robot server 50 confirms whether the input ID and password match the registered ones (step S2).

When determining the input data matches with the registered ones, the robot server 50 looks up the IP address and serial number corresponding to the input ID, and connects to the cleaner robot 70 which has the matching IP address (step S3).

At the same time, the robot server 50 outputs a control screen for the cleaner robot 70 on the display window 26 of the mobile phone 20 (step S4). The control screen may consist of a set menu, a clean menu, and a security menu as in the present particular example of cleaning robot 70.

When the control screen appears on the display window 26 of the mobile phone 20, the user grabs the main body 21 of the mobile phone 20 (see FIG. 7), faces the motion sensor 34 to the bottom, and moves the main body 21. Accordingly, while the motion sensor 34 detects direction and distance of movement of the mobile phone 20, the user moves a cursor on the screen to the desired item of the menu, and selects the item by using the button 24. Therefore, the user can input operation command with convenience (step S5). Alternatively, the operation command can also be inputted without using the motion sensor 34, but using the joystick 30 of the joystick unit 28 which is connected to the mobile phone 20 (see FIG. 6). When using the joystick 30, a control screen may appear for the user's input of operation command. Because the user convenience increases in operating the cleaner robot 70 by the simplified control through movement of main body and control screen, the cleaner robot 70 can be more conveniently operated.

The inputted operation command is transferred to the wireless IP sharing device 60 via the mobile phone 20 and the robot server 50, and transferred to the control part 102 of the cleaner robot 70 via the wireless IP sharing device 60 (step S6). When the inputted operation command is a moving command, the control part 102 controls such that the cleaner robot moves in accordance with the received signal to a designated location, photographs with front camera 76, converts the captured image into image signal, and transmits the converted signal to the wireless IP sharing device 60 via the wireless communication module 108. The image signal received at the wireless IP sharing device 60 is transmitted through the Internet 10 and the robot server 50, and outputted through the display window 26 of the mobile phone (step S7). When the inputted operation command is a cleaning command, the control part 102 controls such that the cleaner robot moves to the designated location, performs cleaning operation, converts images captured through the front and upper cameras 76 and 78 into image signal, and outputs the converted signal through the display window 26 of the mobile phone 20.

The location of the cleaner robot 70 is determined according to the received image signal, and if additional operation is necessary (step S8), operations from operation command input (S5) is repeated, and if not, controlling is completed.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A robot control system comprising:
a wireless IP sharing device connected with the Internet, the wireless IP sharing device transmitting and receiving an image signal and/or a control signal;
a robot running in accordance with the control signal received from the wireless IP sharing device to perform a designated job, the robot being installed with a wireless communication module;
a portable wireless terminal having a motion sensor, the portable wireless terminal wirelessly transmitting an operation command to the wireless communication module and/or receiving the image signal and/or the control signal from the wireless communication module; and
a robot server connected with the Internet, the robot server outputting to the portable wireless terminal a control screen of the robot and the image signal and/or the control signal that is received from the robot, wherein
the robot is controlled by use of the motion sensor installed at the portable wireless terminal.

2. The robot control system of claim 1, wherein the portable wireless terminal comprises a display window for outputting the control screen and a button unit, and wherein the motion sensor is installed at a lower side of the portable wireless terminal.

3. The robot control system of claim 2, wherein the portable wireless terminal further comprises a joystick unit that is selectively connected with a connection socket of the potable wireless terminal, and the robot is controlled by use of the joystick unit.

4. The robot control system of claim 2, wherein the robot is a cleaner robot.

5. A robot control method comprising:
a) inputting an ID and a password using a portable wireless terminal connected with the Internet;
b) determining whether the inputted ID and the password are registered in a robot server;
c) connecting to a robot corresponding to the ID if the ID and the password are registered in the robot server;
d) outputting a control screen of the robot through a display window of the portable wireless terminal;
e) inputting an operation command by use of a motion sensor installed at the portable wireless terminal and the control screen;
f) transmitting the operation command inputted through the portable wireless terminal to the robot via a wireless IP sharing device connected with the Internet; and
g) outputting the image signal and/or the control signal from the robot through the display window of the portable wireless terminal via the wireless IP sharing device.

6. The robot control method of claim 5, wherein inputting an operation command by use of the motion sensor comprises moving the main body of the portable wireless terminal and selecting a menu on the control screen.

7. The robot control method of claim 5, further comprising the step of controlling the control screen by use of a joystick unit which is connected with the portable wireless terminal.

8. The robot control method of claim 6, further comprising the step of the robot performing a cleaning operation.

9. A robot control system comprising:
a robot having a wireless communication module;
a wireless IP sharing device in wireless communication with the communication module of the robot;
a robot server in communication with the wireless IP sharing device via the Internet; and
a portable wireless terminal having a motion sensor in communication with the robot server via the Internet so that the robot is controllable by movement of the portable wireless terminal.

10. The control system of claim 9, wherein the portable wireless terminal comprises a display window for outputting a control screen from the robot server.

11. The control system of claim 9, wherein the motion sensor is installed at a lower side of the portable wireless terminal.

12. The control system of claim 9, wherein the portable wireless terminal further comprises a joystick unit that is selectively connected with a connection socket of the potable wireless terminal so that the robot is controlled by use of the joystick unit.

13. The control system of claim 9, wherein the robot is selected from the group consisting of a cleaner robot, a security robot, an errand robot, and any combinations thereof.

14. The control system of claim 9, wherein the robot server comprises a unique ID and password for each of a plurality of robots.
